(19) United States
(12) Patent Application Publication
(10) Pub. No.: US 2002/0180904 A1
(43) Pub. Date: Dec. 5, 2002

(54) Device for illuminating a liquid crystal screen

(76) Inventors: Frederic De Lauzun, St Medard En Jalles (FR); Alain Bouzinac, St Medard En Jalles (FR); Francois Lopez, Pessac (FR)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 10/148,872

(22) PCT Filed: Dec. 12, 2000
(86) PCT No.: PCT/FR00/03487

(30) Foreign Application Priority Data
Dec. 17, 1999 (FR) 99/15993

(51) Int. Cl. G02F 1/1335

(52) U.S. Cl. 349/61

(57) ABSTRACT

The invention relates to a device for illuminating a liquid crystal screen. The device comprises a light box (1) located behind the screen (2). The light box (1) comprises a plurality of light sources (4). The device further comprises first means (3) to power the light sources (4). The first means (4) comprise second means enabling, under steady conditions, at least one of the light sources to be extinguished while the other sources remain lit.

The invention relates to a device for illuminating a liquid crystal screen. The illumination device usually comprises a light box located behind the screen. The light box comprises a plurality of light sources. The light box illuminates the liquid crystal screen by shining light through the screen.

The light flux emitted by the light box must be a function of the ambient brightness. This is because when the ambient brightness is high, for example in broad daylight, the light flux emitted by the light box must be considerable so that a user is able to perceive the information carried on the liquid crystal screen. On the other hand, when the brightness is low, the user should not be dazzled by the screen and consequently, the light flux emitted by the light box must be reduced.

It is possible to use fluorescent lamps as a light source and, in order to vary the light flux emitted by the light box, all the fluorescent lamps are lit and extinguished simultaneously in a cyclic manner at a sufficiently high frequency so that the user maintains the impression of continuous lighting. The use of fluorescent lamps enables the high illumination level needed to be obtained when the ambient brightness is high, for example when the solar radiation directly illuminates the liquid crystal screen. On the other hand, fluorescent lamps have a substantially shorter life than equipment comprising the liquid crystal screen and its light box. The wear of fluorescent lamps may result either in a reduction in the luminance of the lamps, or in a colorimetric variation or else in a stop in their operation. This wear requires the lamps to be changed during the life of the equipment. It should be noted that reducing the light flux of each lamp, for example by means of the cyclic operation described above, does not substantially increase the life of the lamps.

The aim of the invention is to increase the overall life of the light boxes while using a plurality of light sources which, taken separately, have a life less than the overall life sought for the light box.

This life may be likened to calculating the Mean Time Between Failure (MTBF).

To achieve this aim, the subject of the invention is a device for illuminating a liquid crystal screen, the device comprising a light box located behind the screen, the light box comprising a plurality of light sources, the device further comprising first means to power the light sources, characterized in that the light sources are grouped together in at least two substantially identical groups, and in that the first means comprise second means enabling, under steady conditions, one of the groups of light sources to be extinguished while the other group remains lit.

Advantageously, the light box comprises third means enabling the light emitted by the plurality of light sources to be diffused in order to illuminate the liquid crystal screen in a substantially uniform manner.

When under steady conditions, at least one light source is extinguished, it is more difficult to make the illumination of the liquid crystal screen uniform. To improve this homogeneity, it is possible to increase the distance between the light sources and the third means enabling the light to be diffused. Another advantageous solution consists in using third means which do not substantially absorb the light radiation emitted by the light sources and which comprise a surface internal to the light box reflecting a considerable portion of said radiation. Thus the light radiation reflected by the inner surface of the third means may again be reflected on the other inner walls of the light box until passing through the third means and illuminating the liquid crystal screen.

As a result, the uniformity of the illumination of the liquid crystal screen is improved. It is thus possible to reduce the thickness of the light box, a thickness measured perpendicular to the surface of the liquid crystal screen.

It is important to note that the fact that the light box comprises third means enabling the light emitted by the plurality of light sources to be diffused in order to illuminate the liquid crystal screen in a substantially uniform manner, and that the third means do not substantially absorb the light radiation emitted by the light sources and comprise a surface internal to the light box reflecting a considerable portion of said radiation may be used independently of the fact that the first means comprise second means enabling, under steady conditions, at least one of the light sources to be extinguished while the other sources remain lit and this being so as to improve the uniformity of the illumination of the liquid crystal screen or else so as to reduce the thickness of the light box.

The invention will be better understood and other advantages will become apparent on reading the description of a detailed embodiment of the invention, a description illustrated by the appended drawing in which:

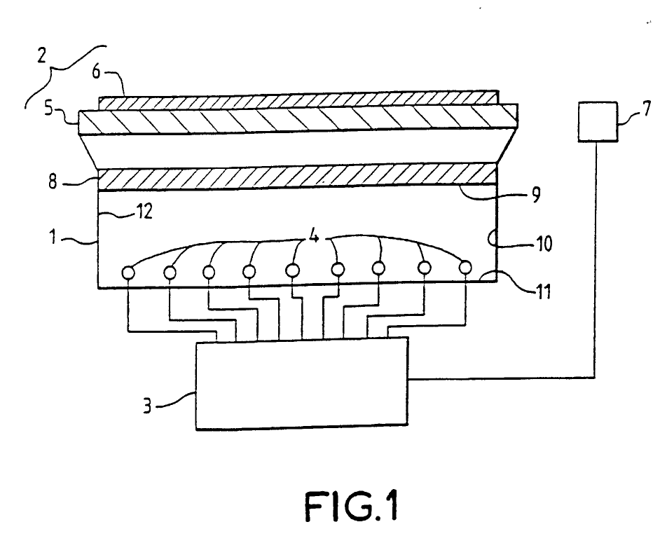

FIG. 1 shows schematically equipment comprising a liquid crystal screen and its illumination device.

The equipment comprises a light box 1, a liquid crystal screen 2 and means 3 to power the light sources 4 belonging to the light box 1. The light box 1 and the means 3 form a device for illuminating the liquid crystal screen 2. The liquid crystal screen comprises two plates 5 and 6 between which the liquid crystals are located. The operation of the liquid crystal screen will not be described in more detail here. The means 3 make it possible, for example by virtue of an electronic circuit, to extinguish at least one of the light sources 4 while the other light sources 4 remain lit and this being so under steady conditions.

It is possible, for example, to produce a light box comprising a large number of substantially identical and aligned light sources 4. A number, representing its position in a line, is allocated to each source. The odd numbered sources in the line are grouped together inside a first group of light sources 4 and the even numbered sources in the line are grouped together in a second group of light sources 4. The two groups are thus substantially identical.

Advantageously, the illumination level of the liquid crystal screen 2 is a function of the ambient brightness, for example measured by means of a photoelectric cell 7. The cell 7 measures the ambient brightness near the liquid crystal screen 2 and transmits its measurement in the form of an electric signal to the means 3.

In practice, the ambient brightness rarely requires the simultaneous lighting of the two groups of light sources 4. For example, in the aeronautics field, specifications require that the liquid crystal screen be visible even when it directly receives solar radiation. In this case, it is necessary to light both groups of light sources 4. In reality, this case is very rarely attained and the majority of the time, a single group of light sources 4 is enough to illuminate the liquid crystal screen.

Consequently, provision can be made so that over a long period, therefore under steady conditions, the lighting of any one group of the two is favored, the other only being lit in the case where the ambient brightness so requires. Provision can, for example, be made to change the favored group once every twenty-four hours or alternatively, every time all the equipment is taken out of service. The favored group is changed independently of the ambient brightness. When one of the groups of light sources 4 is not lit, its life is not curtailed. In this example, the life of all the light sources 4 is very substantially increased.

The fact that the two groups of light sources 4 are substantially identical enables the favored group to be alternated without any consequence to the brightness emitted by the light box.

It is of course possible to vary the light flux emitted by the favored group, or by both groups if required, depending on the ambient brightness, for example by varying the duty cycle of lighting and extinguishing all the lamps of a group. It will be recalled that the cycle time must be short enough so that a user of the liquid crystal screen is not able to notice the cyclic lighting and extinguishing of the light sources 4. The duration of a cycle may for example be 0.02 seconds.

Advantageously, the light box comprises a filter 8 making it possible to diffuse the light emitted by the plurality of light sources 4, so as to illuminate in a homogeneous manner the liquid crystal screen 2.

Advantageously again, the filter 8 does not substantially absorb the light radiation emitted by the light sources 4 and comprises a surface 9 internal to the light box reflecting a considerable portion of the radiation emitted by the light sources 4. The two features described above exist, for example, in a reflecting polarizing filter. More specifically, this involves a filter which lets through only light radiation which is substantially polarized in one direction and which reflects light radiation which is not substantially polarized in said direction.

The reflecting polarizing filter is advantageously combined with a light box 1, the inner walls 10, 11 and 12 of which are made of a substantially nonabsorbent material which reflects substantially all the light radiation emitted by the light sources 4.

A material containing polytetrafluoroethylene is only very slightly absorbing and has a good ability to reflect light radiation emitted by the light sources. Moreover, it is noticed that the polarization of a light ray is altered during reflection from a material containing polytetrafluoroethylene. Thus a light ray emitted by a light source 4 will pass through the filter only when its polarization is appropriate and, if necessary, after several reflections from one of the walls 10, 11, 12 or/and from the inner surface 9. These multiple reflections enable the light flux emitted by the light box 1 and illuminating the liquid crystal screen 2 to be made uniform.

Advantageously, the light sources 4 comprise cold-cathode fluorescent tubes. These tubes have a greater life and a lower cost than hot-cathode tubes.

1. A device for illuminating a liquid crystal screen (2), the device comprising a light box (1) located behind the screen (2), the light box (1) comprising a plurality of light sources (4), the device further comprising first means (3) to power the light sources (4), characterized in that the light sources (4) are grouped together in at least two substantially identical groups, and in that the first means (3) comprise second means enabling, under steady conditions, one of the groups of light sources (4) to be extinguished while the other group remains lit.

2. The device as claimed in claim 1, characterized in that the light box (1) comprises third means (8) enabling the light emitted by the plurality of light sources (4) to be diffused in order to illuminate the liquid crystal screen (2) in a substantially uniform manner.

3. The device as claimed in claim 2, characterized in that the third means (8) do not substantially absorb the light radiation emitted by the light sources (4) and comprise a surface (9) internal to the light box (1) reflecting a considerable portion of said radiation.

4. The device as claimed in claim 3, characterized in that the third means (8) comprise a reflecting polarizing filter.

5. The device as claimed in one of the preceding claims, characterized in that the internal walls (10, 11, 12) of the light box (1) are made of a substantially nonabsorbent material which reflects substantially all the light radiation emitted by the light sources (4).

6. The device as claimed in claim 5, characterized in that the internal walls (10, 11, 12) of the light box (1) consist of polytetrafluoroethylene.

7. The device as claimed in one of the preceding claims, characterized in that the light sources (4) comprise cold-cathode fluorescent tubes.

8. The device as claimed in one of the preceding claims, characterized in that, under steady conditions, the lighting of any group of light sources (4) is favored.

9. The device as claimed in claim 8, characterized in that, periodically, the favored group is changed independently of the ambient brightness.
